(19) United States
(12) Patent Application Publication
(10) Pub. No.: US 2004/0186975 A1
(43) Pub. Date: Sep. 23, 2004

(54) Flash memory data structure and methods of accessing thereof

(75) Inventor: Nakshatra Saha, Bangalore (IN)

Correspondence Address: TEXAS INSTRUMENTS INCORPORATED, P O BOX 655474, M/S 3999, DALLAS, TX, 75265

(73) Assignee: Texas Instruments Incorporated, Dallas, TX

(21) Appl. No.: 10/774,202

(22) Filed: Feb. 6, 2004

Related U.S. Application Data
(60) Provisional application No. 60/456,309, filed on Mar. 20, 2003.

(51) Int. Cl. G06F 12/00

(52) U.S. Cl. 711/170; 711/103

(57) ABSTRACT

A flash memory data structure, a method of writing to flash memory, a flash memory controller for imposing on a flash memory the data structure and a flash memory containing the data structure. In one embodiment, the flash memory data structure includes fixed length cells, each having (1) a control and identifier section for containing (1a) a unique identifier and (1b) a cell count for logically associating multiple of the fixed length cells, and (2) a data section for containing only a configuration value pertaining to the unique identifier.

### CROSS REFERENCE TO PROVISIONAL APPLICATION

This application claims priority from U.S. Provisional Patent Application No. 60/456,309, entitled “Design And Algorithms For Storing/Retrieving Configuration Information To/From Flash Device For Embedded Systems,” filed Mar. 20, 2003, to inventor Nakshatra Saha.

### TECHNICAL FIELD OF THE INVENTION

The present invention is directed, in general, to a flash memory and, more specifically, to a data structure for storing configuration data on the flash memory and a method of writing to flash memory.

### BACKGROUND OF THE INVENTION

Modern computer systems use various types of memory devices including Random Access Memory (RAM) and Read Only Memory (ROM). Computing device often include not only a combination of RAM and ROM but also a hybrid memory device that includes features of both RAM and ROM. An example of a hybrid memory device is an electrically erasable programmable read-only memory (EEPROM), now more commonly known as “flash” memory.

Flash memory is a non-volatile data storage medium typically used to store codes. Vendors, for example, use flash memory to store files, images and device/software configuration information. Flash memory combines the best features of memory devices to provide a high density memory that is electrically re-programmable. Accordingly, flash memory is being used more often in computing devices and has become especially popular among embedded devices, such as modems, IP phones, switches, routers, handhelds, etc.

Flash memory includes a number of memory blocks that can vary in size depending on the manufacturer. Some manufacturers provide tiny blocks in the flash memory. Each memory block stores configuration data that is identified by data names stored as data strings. The configuration data does not span multiple memory blocks but instead is contained within a single memory block identified by the configuration data name string. Thus, the memory blocks must be sufficiently sized to store the largest configuration data resulting in wastage of memory space when storing smaller sized configuration data. Some manufacturers, for example, produce flash memory having memory blocks sized at around 100-200 bytes. Though some configuration data may be only a few bytes in size, the entire memory block of 100-200 bytes is used for storing the data.

Conventional flash memory has additional drawbacks. For example, erasing a single byte or word stored within a memory block is not possible. Instead, an erase operation removes all of the data stored within each memory block. Thus, a memory block is the minimum granularity of a flash memory which can result in a maximum wasted storage space approximately the size of the memory block minus the size of a control section and the configuration data minimally represented by one.

Regarding a write operation, writing to a particular memory block in the flash memory is possible only once and simply modifies certain bit values from 1 to 0. Changing a bit value from 0 to 1 is not possible. Thus, a second write at an address simply erases the configuration data stored in the respective memory block. Accordingly, when updating configuration data in flash memory, an existing file/variable is marked as deleted and a new file/variable is written. Thus, a memory block must be erased before configuration data can be re-written. Effectively twice the memory space of a configuration data, therefore, is often required for storage. Another update of configuration data simply increases the wastage of the storage space. Additionally, more frequent erases will decrease the lifetime of the used memory block producing holes and decreasing the total usable size of the flash memory.

Additionally, compared to other memory mediums, flash memory can be considered slow. For example, a typical access speed for flash memory ranges between 70-150 ns where an access speed in SDRAM is around 7.5 ns. Writing to flash memory can also be inherently slower compared to other memory mediums since writing is often performed byte by byte. Flash memory also has a defined lifetime since the memory blocks may not be erased beyond a defined number of times. Furthermore, flash memory does not provide adequate support for power failures during writes.

Accordingly, what is needed in the art is a flexible flash memory that minimizes wastage of storage space. Additionally, what is needed is a flash memory that provides improved searching and writing along with support for power failures.

### SUMMARY OF THE INVENTION

To address the above-discussed deficiencies of the prior art, the present invention provides a flash memory data structure, a method of writing to flash memory and a method of searching flash memory. Additionally, the present invention provides a flash memory controller for imposing on a flash memory the data structure and a flash memory containing the data structure. In one embodiment, the flash memory data structure includes fixed length cells, each having (1) a control and identifier section for containing (1a) a unique identifier (a number, and not a configuration data string name) and (1b) a cell count for logically associating multiple of the fixed length cells, and (2) a data section for containing only a configuration value (and not a configuration data string name) pertaining to the unique identifier.

The flash memory data structure advantageously employs the unique identifier instead of a configuration data string name to increase available storage space on the flash memory. Additionally, the flash memory data structure employs the cell count to allow configuration values to span across multiple fixed length cells allowing smaller sized cells to reduce storage space wastage. The present invention, therefore, provides a flexible flash memory data structure that optimizes usage of memory space. Additionally, configuration of the flash memory provided by the present invention allows fast lookup mechanisms and power fail safe support.

In yet another embodiment, the present invention provides a method of writing to flash memory with fixed length cells having a control and identifier section and a data section including (1) retrieving an address of a first of the fixed length cells that is free, (2) writing a unique identifier at the address in the control and identifier section, (3) writing a configuration value pertaining to the unique identifier in the data section associated with the address and (4) updating a cell count in the control and identifier section to represent a number of the fixed length cells logically associated.

In a different embodiment, the present invention provides a method of searching for data in flash memory with fixed length cells including (1) locating a first of the fixed length cells that is free and (2) locating the data by searching downward from the first free fixed length cell to other fixed length cells having a lower address thereof.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a block diagram of an embodiment of a memory system constructed according to the principles of the present invention;

FIG. 2 illustrates a block diagram of an embodiment of a flash memory data structure constructed according to the principles of the present invention; and

FIG. 3 illustrates a flow diagram of an embodiment of a method of writing to flash memory carried out according to the principles of the present invention.

FIG. 4 illustrates a flow diagram of another embodiment of a method of writing to flash memory carried out according to the principles of the present invention.

### DETAILED DESCRIPTION

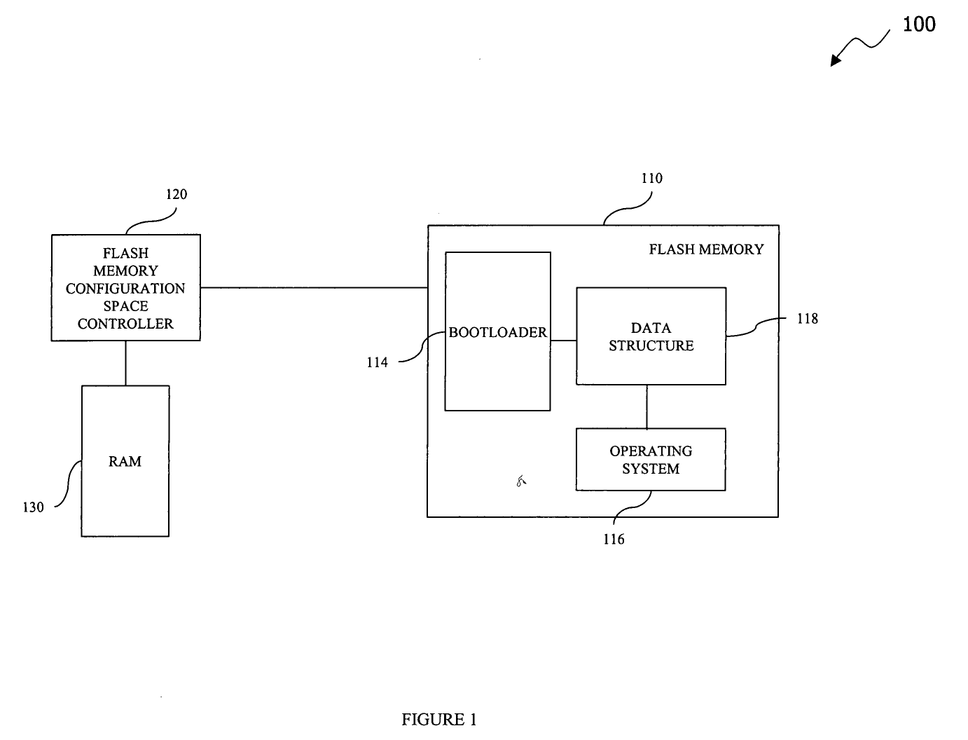

Referring initially to FIG. 1, illustrated is an embodiment of a block diagram of a memory system, generally designated 100, constructed according to the principles of the present invention. The memory system 100 includes a flash memory 110, a flash memory configuration space controller 120 and a random access memory (RAM) 130. The flash memory 110 includes a boot loader 114, an operating system 116 and a data structure 118.

The memory system 100 is typically employed in embedded devices including modems, Voice-over-Internet Protocol (VoIP) phones, routers, switches and various handheld devices such as personal digital assistant (PDAs). In addition to the components illustrated and discussed, one skilled in the art will understand that the memory system 100 may include additional components commonly employed within memory systems of the above devices.

The data structure 118 may be used for configuration space of the flash memory 110. The configuration space is typically configured to hold an integral number of configuration data including configuration parameters and associated configuration values. System designers may employ the data structure 118 to store various system and application specific configuration parameters and corresponding configuration values as the overall system configuration data. Typical configuration parameters include various system properties, (i.e., CPU frequency, system bus frequency, etc), networking parameters, (i.e., interface IP addresses, MAC addresses, subnet-masks, etc), various operation boot commands and application specific parameters (i.e., re-transmission counts, timeouts, etc.). The configuration parameters can vary from system to system based on use and requirements. The configuration parameters may be accessed from the boot loader 114 or the operating system 116. In some embodiments, other applications/images residing on the memory system 100 may also require the configuration parameters.

The data structure 118 includes an array of fixed length cells configured to store the configuration values. Advantageously, configuration space of the data structure 118 is modular and customizable. A size of the configuration space may be modified employing a programming macro embodied, for example, within the flash memory configuration space controller 120. Typically, the programming macro considers the number of fixed length cells that are required to store the configuration data. The configuration space may be sized to about two or three times the required configuration data based on a manufacturing stage of development. For example, a product in a validation phase will typically require more configuration space than a product ready for release. The size of the configuration space therefore can be modified based on the manufacturing stage and the required configuration values.

Each of the fixed length cells includes a control and identifier section and a data section. The control and identifier section contains a unique identifier and a cell count for logically associating multiple of the fixed length cells. The data section contains only a configuration value pertaining to the unique identifier. Each of the fixed length cells equals a minimum storage space for the configuration value.

The unique identifier is a unique number used to represent each of the configuration parameters of the memory system 100. Thus, instead of requiring multiple bytes to store a configuration parameter name string with the configuration value, the unique identifier is stored in the control and identifier section for each configuration data. Accordingly, the data section only stores the associated configuration value, which prevents wastage of flash configuration space.

The cell count enables the configuration value to have a size that is not constrained by a size of the fixed length cells. The cell count stores the number of fixed length cells that includes the configuration value pertaining to each of the unique identifiers. Thus, the fixed length cells having a size less than the configuration value can be logically associated, or concatenated, to further reduce wastage of memory space.

The flash memory configuration space controller 120, coupled to the flash memory 110, is configured to impose the data structure 118 on the flash memory 110. The flash memory configuration space controller 120 may employ a sequence of executable software instructions, dedicated hardware or a combination thereof to impose the data structure. The flash memory configuration space controller 120 may include components commonly employed within a conventional controller associated with flash memory.

The RAM 130, coupled to the flash memory configuration space controller 120, is configured to temporarily store the configuration values before being written to the flash memory 110. This can be used as a scratch pad to work on the configuration data before writing to the flash data structure.

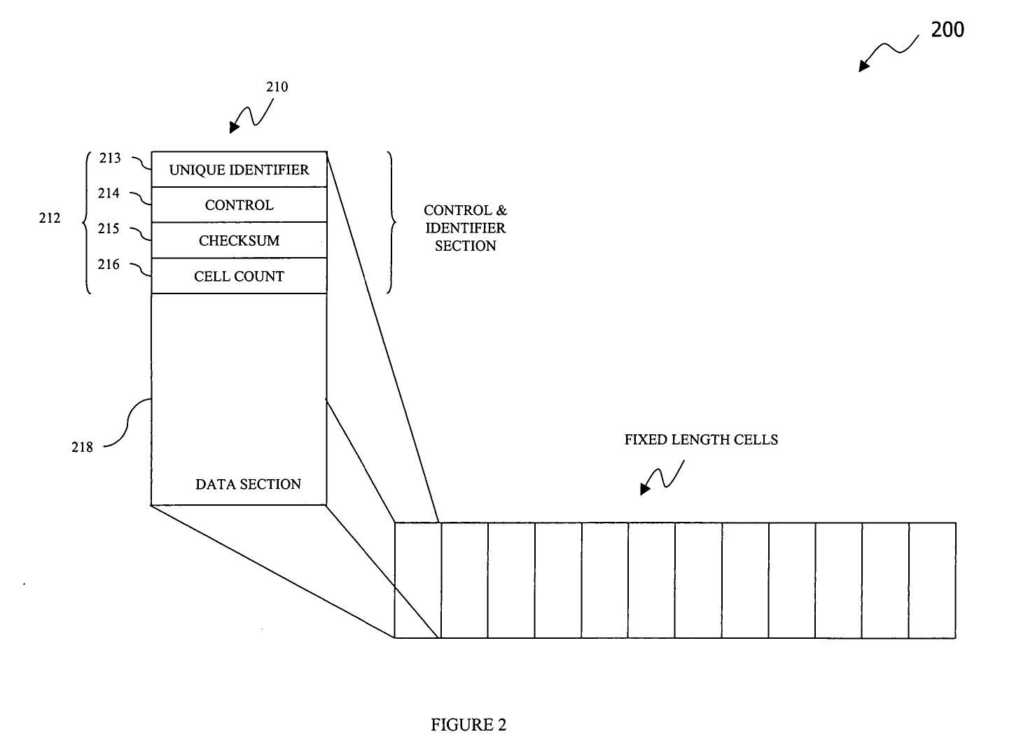

Turning now to FIG. 2, illustrated is an embodiment of a block diagram of a flash memory data structure, generally designated 200, constructed according to the principles of the present invention. The flash memory data structure 200 may be employed in a memory system such as illustrated in FIG. 1. The flash memory data structure 200 includes multiple fixed length cells. For ease of discussion, one of the fixed length cells is designated 210 and selected to represent all of the fixed length cells.

The fixed length cell 210 includes a control and identifier section 212 having fields for a unique identifier 213, a control 214, a checksum 215 and a cell count 216. Additionally, the fixed length cell 210 includes a data section 218 for containing only a configuration value pertaining to the unique identifier 213 (and not a configuration parameter name string). The fixed length cell 210 is 32 bytes long, the control and identifier section 212 is 4 bytes long and the data section 218 is 28 bytes long. The fixed length cell 210 is sized at 32 bytes since this is sufficiently large enough to store a majority of the configuration values. This can also be helpful while using some of the advanced write mechanisms provided by various flash vendors to allow faster write access. This mechanism supports in providing improved system performance and often parallel programming, given lower power consumption. Thus, the fixed length cell 210 sized at 32 bytes can provide a reduction of storage space wastage since a minimum amount of storage space wasted is less than 32 bytes and can advantageously operate with existing flash devices to allow fast write access.

Additionally, having the control and identifier section 212 sized at four bytes long, minimizes a read of the data structure 200 which expedites look-ups of configuration values. For example, on a 32-bit flash data bus, a read is about one cycle long and on a 16-bit flash data bus, a read is about two cycles long for a four byte sized control and identifier section 212. Thus, in a one or two read cycle delay, a single read can provide sufficient information to support a lookup related to a given fixed length cell. With the minimum delay, the unique identifier 213 of the fixed length cell 210 can be known and if a lookup is meant for the configuration value stored in the data section 218. If not, the cell count 216 informs how many fixed length cells to skip to reach the next configuration value. In some embodiments, the lookup delay for 16-bit flash devices can be reduced to one cycle by positioning the unique identifier and count fields in two subsequent bytes at the beginning of the control and identifier section. If the unique identifier 213 indicates a hit, the control 214 indicates whether the configuration value is marked as deleted. If not deleted, the checksum 215 indicates if the configuration value is valid. To speed up processing, the above decisions can be done in a register level of a processor coupled to the data structure 200.

Of course, the size of the fixed length cell 210 may vary in different embodiments. In some embodiments, the fixed length is determined based on optimizing storage space of the data structure 200. Having adequately sized fixed length cells for a majority of the configuration data and using unique identifiers effectively reduces the configuration space. Additionally, having smaller sized fixed length cells allow the accommodation of more fixed length cells within the configuration space that decreases the frequency of erasing flash memory configuration space when it is full. On systems, where configuration values can be much smaller, the size of the fixed length cell 210 can be decreased, for example, to 16 bytes also. This can be supported by decreasing the data section 218 from, for example, 28 to 12 bytes using programming macros.

The unique identifier 213 is a one byte long number given to uniquely identify each configuration parameter instead of storing configuration parameter name strings. Hence, a memory system may include a configuration parameter lookup table that provides a one-to-one correspondence between each of the memory system's configuration parameter and respective unique identifier 213. Employing the unique identifier 213 is advantageous for embedded systems that have pre-defined configuration parameters which are added, updated and retrieved in runtime. The usage of configuration parameter name strings is usually only meaningful for user based systems requiring support for various types of users at runtime or for memory systems that support execution of downloadable applications that add at runtime new configuration parameters based on requirements.

Having the size of unique identifier 213 equal to one byte restricts the possible configuration parameters to 254. Of the possible 256 values that can be held in a 1 byte long variable, zero is left as reserved and the value of 255 is not used since that is the default value of flash memory when it is not written to after erase. A maximum amount of 254 configuration parameters is sufficient for most memory systems. However, the number of configuration parameters can be increased beyond 254.

The control 214 and the checksum 215 are each set at a length of one byte. The control 214 contains management information for the configuration value. A marker employing a single bit of the control 214 is used to denote whether the configuration value is valid or deleted. If deleted, the marker indicates the configuration value is garbage. The other remaining bits are designated as reserve. The checksum 215 is the checksum value of the configuration value stored in the associated data section 218. The checksum 215 may be employed to validate the integrity of the configuration value.

The cell count 216 is one byte long and represents the number of contiguous fixed length cells employed to store the configuration data. When the size of configuration value of a configuration parameter is more than the size of one fixed length cell's data section, subsequent fixed length cells are used, based on the size of the configuration value, to store the configuration data. Under such a scenario, the Control and Identifier Section of only the first fixed length cell is used and the following fixed length cells are concatenated to the first cell's data section. Thus the size of the fixed length cell 210 may be smaller than the configuration value to keep the storage space wastage to a minimum. The size of the cell count 216 being one byte enables the maximum size of a configuration data to be 255 times the size of a fixed length cell.

Thus, each of the fields in the control and identifier section 112 are one byte long. This may vary in other embodiments. For example, the size of the unique identifier 213 may be increased by using most of the control 214 since only a single bit is being used. Additionally, the arrangement of the fixed length cell 210 may vary in different embodiments. Typically, the control and identifier section 112 is located at the beginning of the fixed length cells as illustrated in FIG. 2. In some embodiments, however, the data section 218 is located at a beginning of the fixed length cells and the control and identifier section 212 is located at the end. This will allow a backward search that can increase the speed of searching the data structure 200.

For example considering FIG. 2, every new configuration data is added starting at the address of the first free fixed length cell. After adding new data, the first free fixed length cell address is updated to point to the start of the next immediate free fixed length cell. When a configuration data is updated/modified, the earlier instance of the configuration data, which is located anywhere at a lower address, is marked deleted. Searching of the data structure 200 starts from the base of the configuration space, reading the control and identifier section 212 of each of the fixed length cells holding each configuration data while moving upwards, until the valid, not marked deleted, instance of the desired configuration data is located. In other words, several fixed length cells are typically “hopped-over,” skipping possibly many deleted instances to hit the current valid configuration data.

Hence the valid configuration data is positioned close to the end and the deleted ones are close to the base of the data structure 200. Thus, a faster lookup can be achieved by searching from the end of the data structure 200, or searching from the address of the first free fixed length cell moving downwards. This will provide a faster search compared to conventional flash memory search methods.

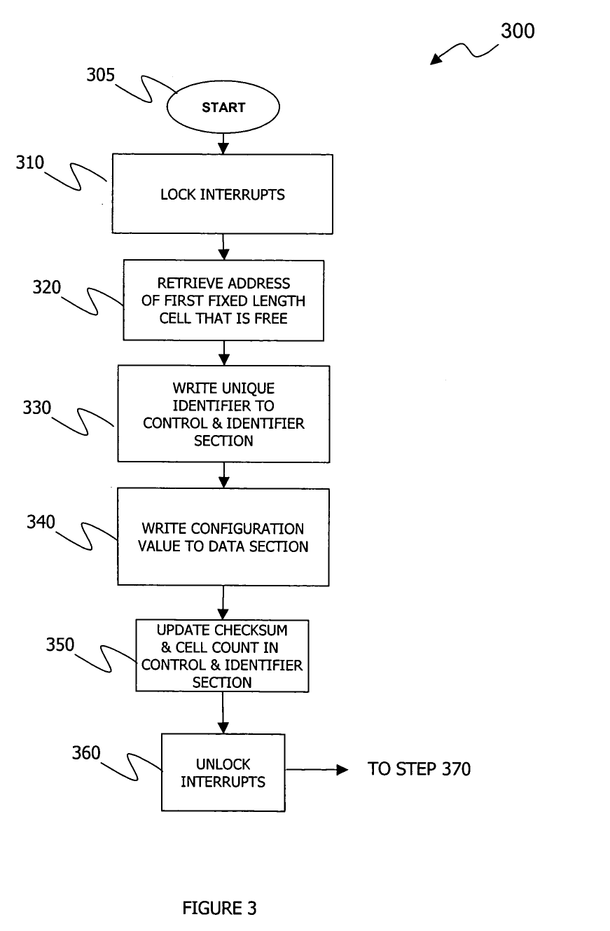

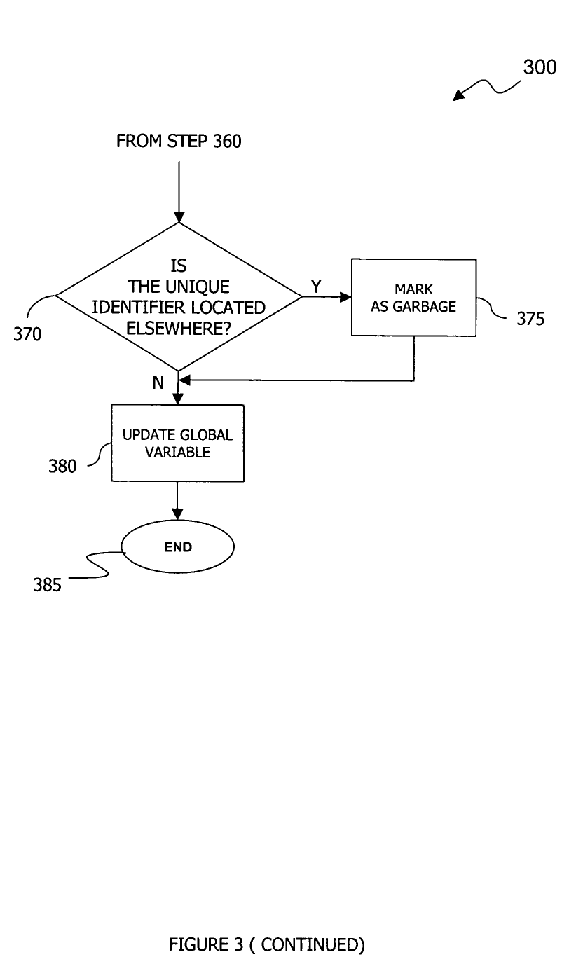

Turning now to FIG. 3, illustrated is a flow diagram of a method of writing a configuration data to flash memory with fixed length cells having a control and identifier section and a data section, generally designated 300, carried out according to the principles of the present invention. The method 300 provides a power fail safe mechanism that is divided into a core and an extended process. The core process can be subdivided into two parts. The first part of the core process identifies and writes essential portions of the configuration data to the flash memory so that if a power failure occurs after successfully completing the first part, the configuration data can still be retrieved on a subsequent power-up initialization process. Advantageously, the first part of the core process is performed as early as possible and in one quick pass to reduce the probability of a negative impact due to a power failure while writing.

On the event of a power failure during the first part and retrieval of the configuration data is not possible on a subsequent system initialization phase, the power fail safe process of method 300 ensures that any previous instance of a configuration data with the same unique identifier is not deleted to at least insure a meaningful value associated with the unique identifier is available. The second part of the core process addresses the completion of the pending steps involved in a write operation of the configuration data. The method 300 is triggered by a intent to write to flash memory in step 305.

After starting, interrupts for a processor are locked in a step 310. Locking the interrupts insures a continuous flow of method 300 by blocking activation of other processing from stealing a slice of crucial processing time during the writing. Additionally, locking the interrupts avoids cache trashing to reduce possible cache misses.

After locking the interrupts, an address of a first of the fixed length cells that is free is retrieved in a step 320. A free fixed length cell is a first available fixed length cell in which configuration data can be stored.

After retrieving the address, a unique identifier for the requested configuration parameter is written to the control and identifier section of the addressed first free fixed length cell in a step 330. Typically, the unique identifier is retrieved from a configuration parameter lookup table to write to the control and identifier section. When the unique identifier has been written, a configuration value pertaining to the configuration parameter is written in the data section associated with the addressed fixed length cell in a step 340. The configuration value may be written to the addressed fixed length cell at a four byte offset. Of course, the offset size may vary depending on the size of the control and identifier section. A scratchpad in a RAM may be used to write the configuration data, parameter and value, before writing to the flash memory to obtain a faster write by employing applicable vendor specific advanced write mechanisms. Successfully completing step 330 marks the completion of the first part of the core process and insures successful retrieval of the configuration data in a backup process on the event of a power failure in subsequent steps.

After writing the configuration value, a checksum of the configuration value and a cell count are updated in the control and identifier section in a step 350. Updating the checksum provides a check on the configuration value and updating the cell count indicates a number of the fixed length cells logically associated.

When the checksum and the cell count are updated, the interrupts are unlocked in a step 360. Unlocking the interrupts ends the process designated as core process. The method 300 continues with the remaining steps designated as the extended process that performs required cleanup of the configuration space due to the addition of the new configuration value.

After unlocking the interrupts, a determination is made if the unique identifier is located elsewhere in the flash memory in a first decision step 370. This happens if there has been a previous valid instance of this configuration parameter associated with the current write. To determine if the unique identifier is located elsewhere, a search of the control and identifier section of the fixed length cells in conducted. In some embodiments, the search may be forward while in other embodiments the search may be backward. At any one point in time, there will only be one valid configuration value for a given unique identifier. Thus, the search may stop once the valid configuration data associated with the unique identifier is located elsewhere in the flash memory. If the unique identifier is located elsewhere, the associated fixed length cell is marked as deleted (or garbage) in a step 375.

If the unique identifier is not located elsewhere, the method continues to the step 380 where a global variable associated with an address of a first of the fixed length cells that is free is updated. Typically to update, the first free fixed length cell immediately following the fixed length cell(s) used in the current write operation is located. The unique identifier of the located cell will hold a value of 0×FF (255). Locating the first free fixed length cell may involve “hopping-over” other fixed length cells in the configuration space. The global variable is then updated with this fixed length cell's address. This ends the extended process for the method 300 which then ends in a step 385. If each of the core and extended processes are completed successfully and no power failure occurs, then a new configuration value has been successfully added.

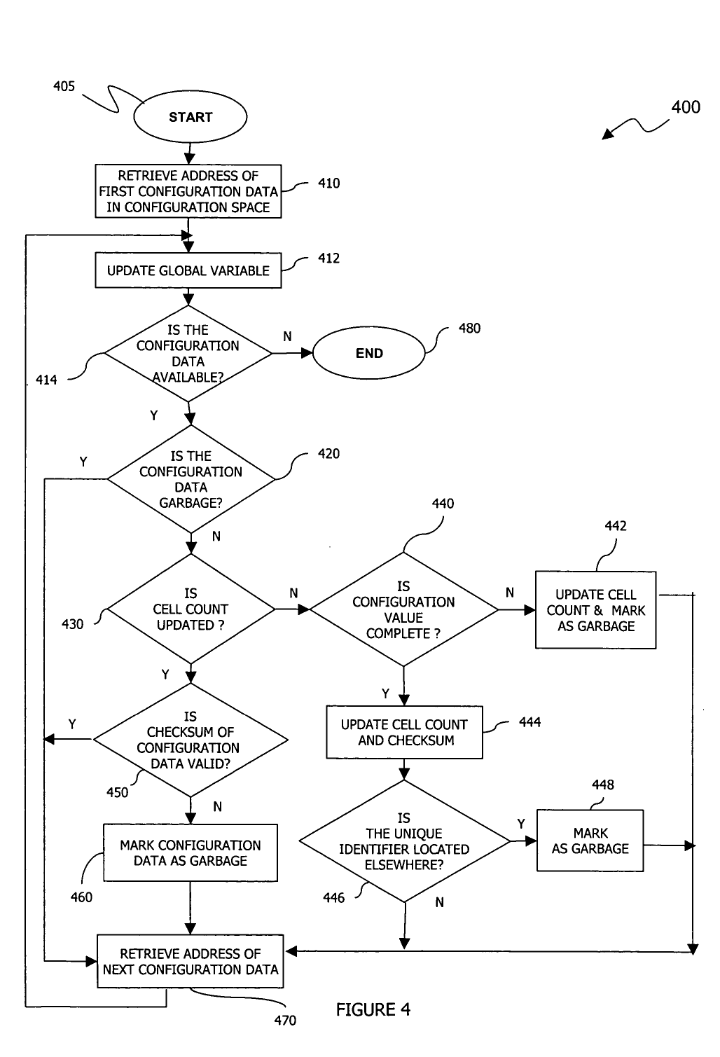

Turning now to FIG. 4, illustrated is a flow diagram of a method of validating configuration data in configuration space and writing to flash memory with fixed length cells having a control and identifier section and a data section, generally designated 400, carried out according to the principles of the present invention. Typically, the method 400 provides a backup process to the core and extended processes as part of the power fail safe process. The method 400 may be executed during a system initialization process. The method 400 is triggered by an intent to validate and write to flash memory in a step 405.

After starting, the address of the first fixed length cell in the configuration space is retrieved in a step in a step 410. This address is then updated in the global variable used to point to the first free fixed length cell in a step 412. A determination is then made if a configuration data is available in the fixed length cell in a first decision step 414. To determine availability, the control and identifier section of the configuration data associated with this fixed length cell is fetched and the respective unique identifier field is retrieved. The determination is then based on the value of the unique identifier. If the value is OXFF, the configuration data is not available and the method 400 continues to a step 480 and ends.

Returning now to step 414, if the value is not 0×FF, the configuration data is available and the method 400 continues to a second decisional step 420 where a determination is made if the configuration data is garbage. The configuration data may be determined garbage, or deleted, based on a control section that contains management information for the configuration data. A marker employing a single bit of the control can be used to denote whether the configuration data is garbage. If the configuration data is garbage, the method 400 continues to a step 470 that is discussed below.

If the configuration data is not garbage, a determination is made if cell count is updated for the configuration data in a third decisional step 430. If not, a power failure most likely occurred during the last write to flash memory of the configuration data in the core process before this field could be written. Therefore, the method 400 proceeds to a step 440 where the configuration value of the last update is tested to determine completeness in a third decision step 440. Incompleteness may be indicated by an occurrence of 0×FF before 0×00. If the configuration value is not complete, the cell count is updated and the configuration value is marked as deleted in a step 442. To mark as deleted, the control field is updated with a garbage marker. The cell count may be updated with the number of fixed length cells this configuration value consumed so that the first free fixed length cell can be used by any future update. The method then continues to step 470.

Returning now to step 440, if the configuration value has been successfully tested for completeness, the number of fixed length cells used to store this configuration data is calculated and used to update the cell count in a step 444. The checksum of the configuration value is also performed and updated if required. After step 444, the method 444 continues to a fifth decisional step 446 that determines if the unique identifier is located elsewhere. This may occur if there has been a previous valid instance of the configuration parameter associated with this configuration data. To determine if the unique identifier is located elsewhere, a search of the control and identifier section of the fixed length cells is conducted. In some embodiments, the search may be forward while in other embodiments the search may be backward. At any given point in time, there will only be one valid configuration data associated with a given unique identifier. Thus, the search may stop once the valid configuration value associated with the unique identifier is located elsewhere in the flash memory. If the unique identifier is located elsewhere, the associated fixed length cell is marked as deleted in a step 448. After marking as deleted, the method 400 then continues to step 470. At step 446, if the unique identifier is not located elsewhere, the method continues to step 470.

Returning now to step 430, if the checksum and cell count are updated, a determination is made if the checksum of the configuration data is validated in a step 450. This step 450 may be performed to increase the reliability of the flash memory. If the checksum is validated, the method 400 continues to step 470. If the configuration data fails a checksum test, the configuration data is marked as a garbage in a step 460 and the method then continues to the step 470. The method 400 may continue until each of the configuration data is fetched.

In the step 470, the address of the next configuration data is retrieved. To retrieve the next configuration data address, the cell count information is retrieved from the control and identifier section of the configuration data. This cell count determines the count of fixed length cells associated with the configuration data and used to retrieve the address of the first fixed length cell immediately following the current configuration data. After retrieving the next configuration data, the method 400 continues to step 412.

While the methods disclosed herein have been described and shown with reference to particular steps performed in a particular order, it will be understood that these steps may be combined, subdivided or reordered to form an equivalent method without departing from the teachings of the present invention. Accordingly, unless specifically indicated herein, the order and/or the grouping of the steps are not limitations of the present invention.

Although the present invention has been described in detail, those skilled in the art should understand that they can make various changes, substitutions and alterations herein without departing from the spirit and scope of the invention in its broadest form.

What is claimed is:

1. A flash memory data structure, comprising:
fixed length cells, each having:
a control and identifier section for containing a unique identifier and a cell count for logically associating multiple of said fixed length cells, and
a data section for containing only a configuration value pertaining to said unique identifier.

2. The data structure recited in claim 1 wherein said unique identifier is one byte long.

3. The data structure recited in claim 1 wherein one of said fixed length cells equals a minimum storage space for said configuration value.

4. The data structure recited in claim 1 wherein said fixed length is determined based on optimizing storage space of said data structure.

5. The data structure recited in claim 1 wherein said fixed length cells are 32 bytes long, said control and identifier section is 4 bytes long and said data section is 28 bytes long.

6. The data structure recited in claim 1 wherein said data section is located at an end of said fixed length cells.

7. The data structure as recited in claim 1 wherein a length of said fixed length cells is configurable by a programming macro.

8. The data structure as recited in claim 1 wherein a size of said data structure is configurable by a programming macro based on a manufacturing stage of development.

9. The data structure as recited in claim 1 wherein said unique identifier corresponds to a configuration parameter in a lookup table.

10. The data structure as recited in claim 1 wherein multiples of said unique identifier correspond to greater than 254 configuration parameters.

11. The data structure as recited in claim 1 wherein said control and identifier section is configurable such that said unique identifier and said cell count are located in subsequent bytes at the beginning of said control and identifier section.

12. A flash memory controller for imposing on a flash memory the data structure as recited in claim 1.

13. A flash memory controller for imposing on a flash memory the data structure as recited in claim 2.

14. A flash memory controller for imposing on a flash memory the data structure as recited in claim 3.

15. A flash memory controller for imposing on a flash memory the data structure as recited in claim 4.

16. A flash memory controller for imposing on a flash memory the data structure as recited in claim 5.

17. A flash memory controller for imposing on a flash memory the data structure as recited in claim 6.

18. A flash memory controller for imposing on a flash memory the data structure as recited in claim 11.

19. A flash memory containing the data structure as recited in claim 1.

20. A flash memory containing the data structure as recited in claim 2.

21. A flash memory containing the data structure as recited in claim 3.

22. A flash memory containing the data structure as recited in claim 4.

23. A flash memory containing the data structure as recited in claim 5.

24. A flash memory containing the data structure as recited in claim 6.

25. A flash memory containing the data structure as recited in claim 11.

26. A method of writing to flash memory with fixed length cells, comprising:
locating a first of said fixed length cells that is free;
writing a unique identifier in a control and identifier section of said first free fixed length cell;
writing a configuration value pertaining to said unique identifier in a data section of said first free fixed length cell; and
updating a cell count in said control and identifier section to represent a number of said fixed length cells logically associated.

27. The method as recited in claim 26 further including locking interrupts and updating a checksum of said configuration value in said control and identifier section.

28. The method as recited in claim 26 further including searching said flash memory for a pre-existing configuration value having said unique identifier and marking said pre-existing configuration value as deleted.

29. The method as recited in claim 26 further including updating a global variable during system initialization with an address of a first of said fixed length cells that is free.

30. The method as recited in claim 29 further including testing said configuration value to determine completeness.

31. The method as recited in claim 30 further including
updating said cell count and marking said configuration value as deleted when determining said configuration value is not complete; and
updating said cell count and a checksum of said configuration value when determining said configuration value is complete.

32. The method as recited in claim 31 further including validating checksums of each of said fixed length cells.

33. A method of searching for data in flash memory with fixed length cells, comprising:
locating a first of said fixed length cells that is free; and
locating said data by searching downward from said first free fixed length cell to other fixed length cells having a lower address thereof.

34. The method as recited in claim 33 wherein said data is configuration data.

35. The method as recited in claim 33 wherein said data is located in a data section at the beginning of said fixed length cells.
